(19) United States
(12) Patent Application Publication
(10) Pub. No.: US 2020/0005686 A1
(43) Pub. Date: Jan. 2, 2020

(54) SYSTEMS AND METHODS FOR PROJECTING A DYNAMIC MATRIX DISPLAY ON AN OUTER SURFACE OF A HOUSING

(71) Applicant: KONINKLIJKE PHILIPS N.V., EINDHOVEN (NL)

(72) Inventor: MARINUS ARNOLDUS MARTINUS VUGTS, BEETSTERZWAAG (NL)

(21) Appl. No.: 16/485,880

(22) PCT Filed: Feb. 7, 2018
(86) PCT No.: PCT/EP2018/053001

§ 371 Date: Aug. 14, 2019

Related U.S. Application Data
(60) Provisional application No. 62/459,088, filed on Feb. 15, 2017.

(51) Int. Cl. G09F 23/00; G09F 13/22; G09F 9/33

(52) U.S. Cl. CPC G09F 23/0075; G09F 2013/222; G09F 9/33; G09F 13/22

(57) ABSTRACT

A power device including a first light source (202A) arranged in a housing (205) having an outer surface; a first mask (204) arranged around the first light source in the housing and including a first chamber (207A) corresponding to the first light source; and a transmissive display arranged between the first light source and the outer surface of the housing, light (214) emitted from the first light source reaching the transmissive display before reaching the outer surface of the housing and projecting a plurality of images (212) on a first area (140, 216) on the outer surface of the housing.

This application is a continuation-in-part of U.S. provisional patent application 62/311,982, filed 23 Mar. 2016, the content of which is incorporated by reference in its entirety herein.

### FIELD OF THE INVENTION

The present disclosure generally relates to systems and methods for directing light emitted from one or more light sources within a housing through a transmissive display to project one or more images on one or multiple areas of an outer surface of the housing.

### BACKGROUND

Several types of display systems for various electronic devices exist. For example, conventional display systems for power toothbrushes include white or color displays created by laser ablation. Other display systems for electronic devices include projected displays in white or red, for example, on a face of an alarm clock.

However, such display systems are limited in display dynamics and/or use a relatively large “user interface real estate,” and each of the display system elements are limited to being separately projected adjacent to one another. Conventional display systems do not provide the capability to display multiple icons or other designs at the same spot or common area of a (white or color coated/painted) device. This can be problematic, especially in circumstances where one would like to display multiple icons on the surface of a single device with limited “user interface real estate,” such as on certain power hand-held devices.

Typically, foils are used to display static icons on surfaces of devices. However, such display systems using foils are limited in display dynamics since the foils include fixed pre-determined static icons.

Accordingly, there is a need in the art for systems and methods for directing light emitted from one or more light sources within a housing to project an unlimited variety of images including dynamic images on one or more areas of an outer surface of the housing.

### SUMMARY OF THE INVENTION

The present disclosure is directed to inventive systems and methods for directing light emitted from one or more light sources within a housing through chambers (one or more of which may be angled) formed by masks and through a transmissive display to project any number of images on one or more areas of an outer surface of the housing (either simultaneously or sequentially) that can be a white or color painted body. The projection can take place on the “skin” of the outer housing, where the skin is created by a paint or matte texture etc. (as should be appreciated by a person of ordinary skill in the art in conjunction with a review of this disclosure). For example, a combination of first and second projected images can create a dynamic blended image on the surface. Alternatively, a projected image can change in size. Further, the first image can transition to the second image. Further, the second image can be projected on the surface after the projection of first image has stopped. Stacked images can also be projected in multicolor. The use of multiplexing (or time sharing) facilitates with mixing projections to control multiple images independently projected at a single area or at multiple areas.

An advantage of the projection systems and methods disclosed herein is that the transmissive display provides the ability to project dynamic images as opposed to static icons projected with pre-determined fixed foils.

The housing can be part of any power device (hand-held or non-hand-held) such as health care devices and dental/oral care devices including power toothbrushes. Using the embodiments and implementations herein, brushing behavior and cleaning of teeth, for example, can be substantially improved and a user can stay informed regarding the status of his/her power toothbrush.

In some embodiments, an image can be projected on an outer surface of a housing that at least partially wraps around the curved outer surface of housing (where the housing is at least partially curved). This “wrapping” feature can be accomplished by a mask arrangement that isolates light emitted from the multiple light sources in a diverging manner to separate areas on the curved outer surface of the housing. Stated differently, the masks that surround and form the chambers that house each of the light sources can be angled in a particular manner/configuration within the housing to provide the “wrapping” feature (by, in part, projecting an image corresponding to a defined transparent area of the transmissive display on the curved outer surface of the housing).

Generally in one aspect, a power device is provided. The power device includes: a first light source arranged in a housing having an outer surface; a first mask arranged around the first light source in the housing and including a first chamber corresponding to the first light source; and a transmissive display arranged between the first light source and the outer surface of the housing, light emitted from the first light source reaching the transmissive display before reaching the outer surface of the housing and projecting a plurality of images on a first area on the outer surface of the housing.

According to an embodiment, the first light source is a single color light emitting diode.

According to an embodiment, the first light source is a multi-color light emitting diode.

According to an embodiment, the transmissive display is a transmissive matrix display or a transmissive segment display.

According to an embodiment, the projected images are created on a semitransparent paint system.

According to an embodiment, the power device further includes a second light source arranged proximate to the first light source and within the first chamber.

According to an embodiment, the first and second light sources comprise a respective longitudinal axis, and light emitted from the first light source on the first area of the housing at least partially overlaps with light emitted from the second light source.

According to an embodiment, the power device further includes a second light source arranged in the housing and a second chamber arranged around the second light source in the housing, light emitted from the second light source reaching the transmissive display before reaching the outer surface of the housing and projecting a second plurality of images on a second area on the outer surface of the housing, wherein the first and second chambers are not angled.

Generally in another aspect, a power device is provided. The power device includes: a plurality of light sources arranged in a housing having an outer surface; a mask arranged around each of the plurality of light sources in the housing and including a plurality of chambers corresponding to the plurality of light sources; and a transmissive display arranged between the plurality of light sources and the outer surface of the housing, light emitted from each of the plurality of light sources reaching the transmissive display before reaching the outer surface of the housing and projecting a plurality of images on at least two separate areas on the outer surface of the housing.

According to an embodiment, at least one of the plurality of chambers includes an angled surface and a non-angled surface.

According to an embodiment, the plurality of light sources includes light emitting diodes having limited angle dependent intensity profiles.

According to an embodiment, the plurality of images being projected on the outer surface of the housing wraps around the outer surface.

According to an embodiment, the one or more light sources are arranged on a flat or curved substrate within the housing.

According to an embodiment, multiple images being projected on the curved outer surface of the housing results in a dynamic blended image that wraps around the curved outer surface.

Generally in another aspect, a method of displaying multiple images on one or more areas of a power device is provided. The method includes the steps of: providing a housing containing a first light source, a mask arranged around the first light source, and including a first chamber, and a transmissive display arranged between the first light source and the one or more areas of the power device; causing light to be emitted from the first light source, the emitted light reaching the transmissive display before reaching the one or more areas; and selectively obstructing the emitted light by defining one or more transparent areas in the transmissive display to project multiple images on the one or more areas of the power device.

According to an embodiment, the method further comprises projecting two images on the one or more areas of the housing depending on activation of sub-units of the transmissive display in the following sequence and the first light source: projecting a first image; turning off the first image; projecting a second image; and projecting the first image before turning off the second image to create a dynamic blending of the first and second images.

According to an embodiment, the method further comprises projecting two images on the one or more areas of the housing depending on activation of sub-units of the transmissive display in the following sequence and the first light source: projecting a first image; turning off the projection of first image; projecting a second image; and turning off the second image before projecting the first image again to create a dynamic blending of the first and second images.

According to an embodiment, the step of selectively obstructing the emitted light comprises projecting a first image and a second image alternatingly such that they appear to be projected at the same time.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), laser diodes, electroluminescent strips, and the like. It should also be understood that the term LED does not limit the physical and/or electrical package type of an LED.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, and other types of electroluminescent sources.

As used herein for purposes of the present disclosure, the term “controller” is used generally to describe various apparatus relating to the operation of a stream probe apparatus, system, or method. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present disclosure discussed herein. The terms “program” or “computer program” are used herein in a generic sense to refer to any type of computer code (e.g., software or microcode) that can be employed to program one or more processors or controllers.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

These and other aspects of the invention will be apparent from and elucidated with reference to the embodiment(s) described hereinafter.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a front view of a power toothbrush having a projected display system in accordance with an embodiment.

FIG. 2 is a schematic representation of a projected display system of a power toothbrush in accordance with an embodiment.

FIG. 3 is a sectional view of a projected display system within a body portion/handle of the power toothbrush of FIG. 1 in accordance with an embodiment.

FIG. 4 is a sectional view of a projected display system within a body portion/handle of the power toothbrush of FIG. 1 in accordance with an embodiment.

FIG. 5 is a sectional view of a projected display system within a body portion/handle of the power toothbrush of FIG. 1 in accordance with an embodiment.

FIG. 6 is a sectional view of a projected display system within a body portion/handle of the power toothbrush of FIG. 1 in accordance with an embodiment.

FIG. 7 is a sectional view of a projected display system within a body portion/handle of the power toothbrush of FIG. 1 in accordance with an embodiment.

FIG. 8 is a graphical illustration of time sharing multiple images at one or more locations in accordance with an embodiment.

FIG. 9 is a graphical illustration of time sharing multiple images at one or more locations in accordance with an embodiment.

FIG. 10A is a graphical illustration of an angle dependent intensity profile of an LED light source in one direction in accordance with an embodiment.

FIG. 10B is a graphical illustration of an angle dependent intensity profile of an LED light source in one direction in accordance with an embodiment.

FIG. 11A is a schematic representation of a power device having a projected display system in accordance with an embodiment.

FIG. 11B is a schematic representation of a power device having a projected display system in accordance with an embodiment.

FIG. 12A is a schematic representation of a power device having a projected display system in accordance with an embodiment.

FIG. 12B is a schematic representation of a power device having a projected display system in accordance with an embodiment.

FIG. 12C is a schematic representation of a power device having a projected display system in accordance with an embodiment.

### DETAILED DESCRIPTION OF EMBODIMENTS

The present disclosure is directed to projecting a plurality of images on one or more areas of an outer surface of a housing based on a configuration of one or more light sources within one or more chambers formed by at least one mask within the housing and a transmissive display. Images can be projected to create dynamic blended or stacked images by backlighting a transmissive dynamic matrix display. Instead of projecting fixed pre-determined icons, any number of images can be projected at an individual spot and/or at multiple spots on a body and/or on a painted function knob or separate panel in a body by creating certain individual angular projections with or without an additional lens, and in the same color or different colors. Angular display masks can facilitate the angular projections. Using the various embodiments and implementations herein, projected images on the areas can include brushing information/indications for a user's benefit. Advantageously, the projection systems and methods disclosed herein use a transmissive display within a housing to project dynamic images instead of foils which contain static icons.

A particular non-limiting goal of utilization of the embodiments and implementations herein is to provide brushing information/indications to a user of a power toothbrush, e.g., a Philips Sonicare™ toothbrush (manufactured by Koninklijke Philips Electronics, N.V.). Such information can, for example, be related to error or alert messages (e.g., battery due to be changed/charged, change brush head), instruction or indications related to proper use of the power toothbrush, timer, sensory result messages (e.g., fully cleaned teeth, partially cleaned teeth, good brushing behavior, poor brushing behavior, plaque formation). According to other embodiments and implementations, pertinent information/indications can be provided to users of any power medical, dental, shaving, grooming, mother and child care devices (handheld and non-handheld), for example, which can incorporate the configurations and functionalities described herein (as should be appreciated by a person of ordinary skill in the art in conjunction with a review of this disclosure).

Advantages of embodiments are illustrated by the following description of an exemplary power toothbrush 100 embodiment including a projected display system 200. However, the particular components, uses, functionalities and amounts thereof recited in this description, as well as other conditions and details, are to be interpreted to apply broadly in the art and should not be construed to unduly restrict or limit the invention in any way.

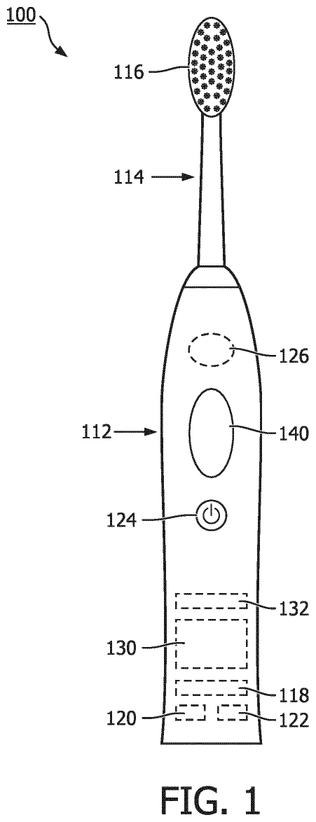

Turning to FIG. 1, a front view of a power toothbrush is shown, in accordance with an embodiment. The power toothbrush, shown generally at 100, includes in general a body portion 112, a neck portion 114, and a brush head portion 116 with bristles. The body portion/handle 112 includes a drive assembly/circuit 118, a control unit 120, and a power source 122 (e.g., battery or power cord) for producing a brush head motion suitable for effective cleaning of teeth. The illustrative elements are shown representationally because they are conventional in the art of power toothbrushes. The operation of the toothbrush itself is controlled by an on/off switch 124. The particular configuration and arrangement shown in FIG. 1 is by way of example only and does not limit the scope of the embodiments disclosed below.

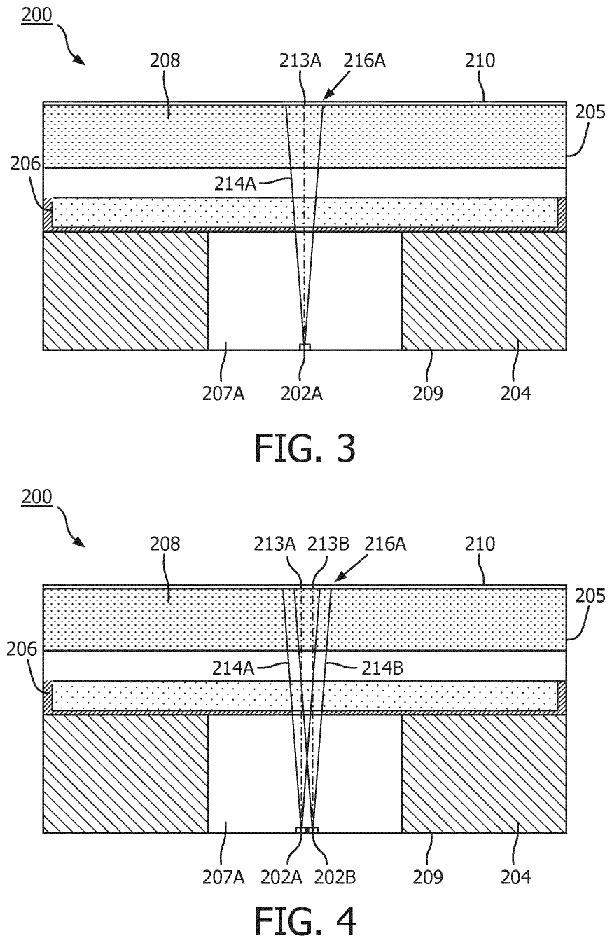

The power toothbrush 100 can include one or more sensors 126 located on or within the toothbrush. Sensor 126 is shown on FIG. 1 near the top of the body portion/handle 112, but may be located anywhere on the device, including, for example, on the neck portion 114 or brush head portion 116, to sense brushing information. Processor 130 is preferably located within the toothbrush and configured to process sensor information obtained from sensor 126. Display area 140, which may be located on the toothbrush and associated with a projected display system 200 (discussed further with reference to FIGS. 3-7 below) on and/or within the toothbrush, can be responsive to a processor and configured to communicate brushing information/indications to the user. In some embodiments, display area 140 can be located on and/or within the switch 124. Alternatively, display area 140 can be located on a painted function knob or separate panel in a body. In some embodiments, a storage system/memory 132 for storing brushing information may be included for further analysis of information.

Many types of sensors can be used with the present disclosure. In some embodiments, for example, a force sensor can be used to detect bristle pressure, load, or force applied against the teeth. Such force sensors can take various forms, including, for example, Hall Effect sensors or other known mechanical or magnetic sensors. In other embodiments, a plaque detection sensor can be used to detect the presence of plaque on the teeth. For example, a pressure sensor can be configured to measure feedback from air applied to a dental surface to characterize the dental surface. In some embodiments, a gum detection sensor can be used to detect whether the bristle set is brushing gums rather than teeth. In further embodiments, a MEMS (micro-electro-mechanical system) gyroscope and an accelerometer can be positioned on the brush head to detect rotational velocity of the brush head and orientation of the brush head during the mouth during operation. In other embodiments, infrared sensors can be used to determine the position of the bristle set in the mouth of the user. The particular form of sensor is not an essential part of the present system, as long as the sensor is accurate.

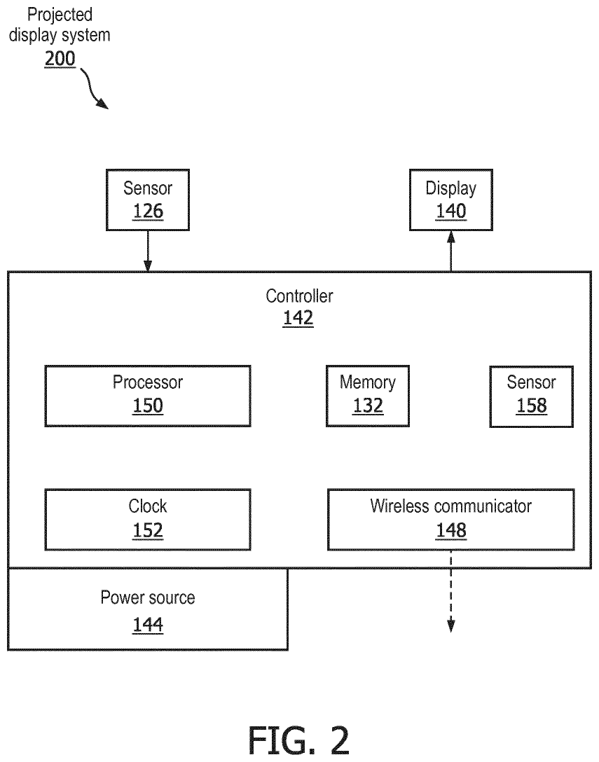

Referring to FIG. 2, a schematic representation of the basic control components of projected display system 200 is provided. As described herein, projected display system 200 can be programmed and/or configured to direct light emitted from one or more LED light sources within a housing of a power device through a selectively controllable transmissive display to project one or more images on one or more areas of an outer surface of the housing. According to an embodiment, the control components of projected display system 200 include a controller 142 that is programmed and/or configured to analyze information/data, transmit/receive information, data and/or commands (control signals) from/to each of the other respective components of the projected display system 200 or external components/devices as may be appropriate to carry out the functions and methods described herein (as should be appreciated and understood by those of skill in the art in conjunction with a review of this disclosure). Information/data that can be analyzed and/or used by the controller 142 to carry out the functions and methods described herein can be received from one or more sensor components, and the controller 142 can be programmed and/or configured to effectuate the projection of one or more images on one or more areas of an outer surface of a housing (as described herein) as a result of the received (and optionally thereafter analyzed) information/data from the one or more sensors.

According to a further embodiment, the control components of projected display system 200 can also include, for example, a sensor 126, a power source 144, and display 140. Power source 144 may be the same as power source 122 for the toothbrush 100, or can be a separate power source. Sensor 126 can be any of the sensors described or otherwise envisioned herein, and is programmed and/or configured to obtain sensor data regarding one or more aspects of the user's mouth during a brushing session. For example, the sensor may obtain information/data about the teeth surface, plaque levels, brushing areas, brushing strength, brushing angle, overall brushing effectiveness, and/or a wide variety of other aspects of dental health as described elsewhere herein. The sensor data may also relate to the operating status (on/off condition, normal condition, abnormal condition, battery life, and speed of the motor) of the power toothbrush 100 and other related data.

Controller 142 can receive sensor data from sensor 126 in real-time or periodically. For example, sensor 126 may send a constant stream of sensor data to controller 142 for storage and/or analysis, or may temporarily store and aggregate or process data prior to sending it to controller 142. Once received by the controller, the sensor data from the brushing session can be processed by processor 150. Processor 150 may be the same as processor 130, or can be a separate processor. According to an embodiment, the processing can comprise one or more of the steps of: (i) normalizing or otherwise processing the sensor data for further analysis; (ii) retrieving stored pre-programmed or user-defined brushing standards from memory 132 (which can be inputted into the power toothbrush 100 as should be appreciated by a person of ordinary skill in the art in conjunction with a review of this disclosure); (iii) comparing the sensor data to the retrieved standards; (iv) determining if there are any sensor data that differ sufficiently (beyond a pre-defined threshold) from the retrieved standards; (v) determining whether the differing sensor data triggers an output to the user based on the stored standards; and (vi) outputting data to the user in the form of a projection to the display 140 regarding the triggering sensor data. In other words, sensor data can be compared to pre-programmed standards to determine if a particular image to be projected on one or more areas of an outer surface of the housing (e.g., display area 140) is warranted. Additionally, the timing of the projection of a particular image on a display area 140 can be in real time, or periodically. As further described herein, multiple images can be blended or stacked on a display area or multiple areas by mixing projections by image multiplexing using single color or multi-color LEDs.

As one example, the sensor data can be brushing strength, or information about how hard, how soft, and/or how effectively the user is brushing his/her teeth. The controller 142 can determine, using sensor data, how hard the user is brushing his/her teeth. Processor 150 can pull pre-programmed brushing strength levels from memory 132 and compare that to the obtained sensor data to determine that the user is not brushing his/her teeth sufficiently hard. In other words, the strength levels obtained from the sensor data fall beneath a pre-determined minimum threshold of strength levels for that user and/or that time of day. For example, different users and different times of day or different days of the week may require different brushing strength levels, and each of these can be stored in memory 132 for appropriate recall. Clock 152 may be utilized by controller 142 in order to determine the brushing time, duration, and date, and may be utilized by controller 142 in order to recall the appropriate standards from memory 132. Processor 150 can further determine, based on stored information, what response may be necessary for improper brushing strength levels, and can pull from memory 132 the appropriate image(s) to be projected on display 140. For example, if the brushing strength is too low, the controller 142 can be programmed and/or configured to effectuate the selective projection of an up arrow (to indicate to the user to increase his/her brushing strength) on display 140.

The controller can be programmed and/or configured to effectuate the selective projections of dynamic images (for example, dynamic facial expressions to indicate whether the user is exhibiting healthy or poor brushing behavior and/or plaque formation) on display 140. The face can transition between expressions indicating healthy or poor brushing behavior and/or plaque formation. For example, when the user is not brushing his/her teeth, the projected image can include a face with a neutral expression. When the user is brushing his/her teeth, the projected image of the face can change to a face with a positive expression (to indicate healthy behavior) or a face with a negative expression (to indicate poor behavior). The projected image of the face can also change to indicate varying degrees of healthy or poor behavior. By way of another example, a spotlight can be displayed at one location and then again at another location so quickly such that the spotlight appears to be a single spotlight projection that is displaced on the surface. Alternatively, a white pictogram and a red cross can be displayed in an alternating fashion at a single common area such that they appear to be projected at the same time using a single multi-color LED in a single chamber of a mask.

Projected display system 200 may also include a wireless communicator 148 for transmitting sensor data to a wireless transceiver (not shown). For example, wireless communicator 148 may transmit sensor data via a WiFi connection over the Internet or an Intranet to a dental professional, a database, or other location. Alternatively, wireless communicator 148 may transmit sensor data via a Bluetooth® or other wireless technology to a local device, database, or other transceiver. A wireless communicator 148 allows the user to save sensor data for long-term storage, to transmit sensor data for further analysis, or share data with a dental professional, among other uses. Wireless communicator 148 may also be a transceiver that can receive user input information, including the above referenced standards (as should be appreciated by a person of ordinary skill in the art in conjunction with a review of this disclosure).

Projected display system 200 may also include sensor 158 configured to detect that the user has picked up the toothbrush or removed it from a cradle and is about to use the toothbrush and can then activate the projected display system 200. The sensor 158 can be, for example, a motion sensor that detects that the toothbrush is being picked up and/or positioned for use. For example, the sensor 158 may detect motion using a variety of different motion-detecting sensors, and can send a signal to the processor 150 that the user has picked up the toothbrush and that an appropriate image can be projected on display 140 as may be appropriate during a brushing event (although, information about the power toothbrush 100 itself (such as charging status) can be sensed by either sensor 126 or 158 and projected on display 140 at any time).

According to an embodiment, historically gathered data may be sensed by sensor 126 and/or sensor 158, gathered and stored in memory 132. For example, a toothbrush may contain memory which can store, for example, an average value per day (e.g., brushing strength), week, month, etc. A particular image can be projected on display area 140 indicating to the user that his/her brushing strength has improved or worsened over time.

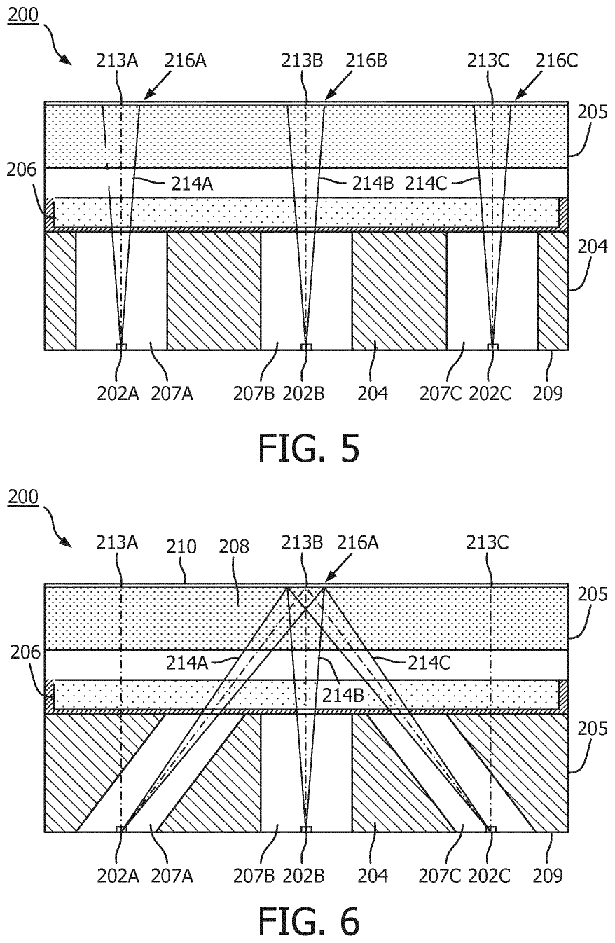

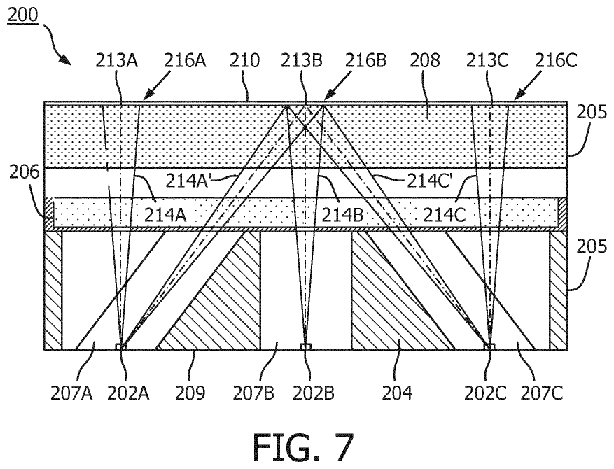

Referring to FIGS. 3-7, sectional views of the projected display system 200 within body portion/handle 112 of FIG. 1 are shown. The projected display system 200 includes one or more LED light sources 202A, 202B, and 202C positioned within a housing 205 on a substrate 209. The substrate 209 can be flat or curved such as a flexible printed circuit board assembly, for example. Each of the LED light sources 202A, 202B, and 202C includes a respective longitudinal axis 213A, 213B, and 213C, and is surrounded by a mask 204 within housing 205, the mask forming chambers 207A, 207B, and 207C for each respective LED light source 202A, 202B, and 202C. The chambers isolate the respective light sources. In the example embodiments shown in FIGS. 3 and 4, there is a single chamber which is not angled. In the example embodiment shown in FIG. 5, there are three non-angled chambers 207A, 207B, and 207C. In the example embodiment shown in FIG. 6, chambers 207A and 207C are positioned at an angle relative to the respective longitudinal axes 213A and 213C from the position of each LED 202A and 202C toward chamber 207B. Chamber 207B is not shown positioned at an angle to the longitudinal axis 213B. In the embodiment shown in FIG. 7, each of chambers 207A and 207C includes a non-angled surface and an angled surface where the angled surface extends toward chamber 207B. Although not shown, various combinations of angled and non-angled chambers are contemplated as long as the projected images pursuant to light emitted from one or more LEDs through the transmissive display forms on one or more areas on an outer surface of the housing 205. Alternatively, the display can be a separate panel of the housing 205 or an on/off knob or other function knob (as should be appreciated by a person of ordinary skill in the art in conjunction with a review of this disclosure).

Transmissive display 206 can be any suitable display that is backlit by the one or more LED light sources and provides projected images. For example, transmissive display 206 can be a liquid crystal display including segments forming parts of a number, letter, or any other image. The segments can be dots or pixels and can be arranged in rows and columns. The segments can be turned “on” and “off” individually (or selectively blocked) to either block or allow light to pass through. When the segment is blocked, light does not pass through. When the segment is not blocked, light passes through to project the light in the unobstructed light path on the semitransparent paint system where the image is formed. The transmissive display 206 can be a passive or active matrix liquid crystal display by way of examples. An example transmissive display 206 includes display glass, drive electronics, control electronics, mechanical package, and a power supply. The display glass can be substituted with any suitable alternative. The display glass can include electrodes and contact pads to connect drive electronics to each electrode. The drive electronics can be integrated circuits that supply current to drive the electrodes. Each pixel can be controlled by an intersection of two conductors. When a potential voltage difference is created at an intersection, the liquid crystal fluid can respond by creating an “on” state at that intersection, also commonly referred to as a pixel. An example suitable transmissive display includes red, green, and blue sub-pixels in each pixel. An example transmissive display can be a curved flexible substrate.

An example transmissive display 206 includes transparent electrode patterns made of indium tin oxide using a photolithography or silkscreening process. However, any suitable alternative can be used instead.

In FIG. 3, a single LED light source 202A is positioned within a single chamber 207A. Light 214A is emitted from LED light source 202A along longitudinal axis 213A through transmissive display 206. LED light source 202A can be a single color LED or a multi-color LED. Chamber 207A guides the emitted light to transmissive display 206. Transmissive display 206 is induced by electrical fields to form patterns (or transparent areas) which block or allow light to pass therethrough. The light allowed to pass through each sub-pixel is controlled to create any picture including a large variety of different colors. For example, if light source 202A is a multi-color LED, a white pictogram including a red cross can be projected by a single light source by alternating the white pictogram and the red cross so quickly that they appear to be projected at the same time. Thus, any number of images can be projected on area 216A on an outer surface of the housing 205. Additionally, blended or stacked images can be projected on area 216A using transmissive display 206 and time sharing, as described further below.

The discussion above applies to FIG. 4, except as noted. In FIG. 4, two light sources 202A and 202B are positioned within a single chamber 207A. Light paths 214A and 214B are emitted through transmissive display 206 which can selectively obstruct the light paths leading to a projection of the emitted light. In an example embodiment, light source 202A can be a first color and light source 202B can be a second color which can be the same or different than the color of the first light source 202A. Since each light source 202A and 202B emits light along independent respective longitudinal axes 213A and 213B within the same chamber 207A, when both light sources are emitting light at the same time, the images created by the transmissive display 206 can be projected twice under different angles causing undesirable double images. To avoid the projection of undesirable double images driven by a plurality of light sources within a single chamber, images can be projected in alternating fashion by independently controlling the light sources.

The discussion above applies to FIG. 5 except as noted. In FIG. 5, multiple images 216A, 216B, and 216C are driven by multiple LEDs 202A, 202B, and 202C, each in a separate chamber 207A, 207B, 207C, respectively. In this embodiment, three images can be projected onto the outer surface of the housing 205, and controlled independently. In alternate embodiments, additional or fewer images can be projected onto different areas of the by additional or fewer LEDs.

Unlike the example embodiments described above and shown in FIGS. 3-5, the example embodiment shown in FIG. 6 projects multiple images driven by multiple LEDs. 202A, 202B, 202C onto a single location 216A, on the outer surface of the housing 205. No time sharing is used since each LED is positioned in a different chamber, 207A, 207B, 207C. Each chamber isolates the light emitted from the corresponding LED from light emitted from other LEDs. As shown in FIG. 6, LED light sources 202A and 202C are positioned within respective angled chambers 207A and 207C. Light paths 214A and 214C are emitted from LED light sources 202A and 202C at an angle relative to the respective longitudinal axes 213A and 213C and through the transmissive display 206. The angled chambers 207A and 207C are formed to isolate and guide the light emitted from the LED light sources 202A and 202C at the referenced angles to the respective longitudinal axes. Each LED light source 202A and 202C can also be positioned on a surface or substrate that is angled relative to the respective longitudinal axes 213A and 213C (preferably in the same direction of the angled chambers 207A and 207C) within the angled chambers 207A and 207C. LED light source 202B is positioned within chamber 207B. Light is emitted from LED light source 202B along the longitudinal axis 213B and through the transmissive display 206. The light emitted from each of the LED light sources 202A, 202B and 202C can pass through a carrier 208 and paint system 210 to form corresponding projected images on area 216A on the outer surface of the housing 205 as a function of the configuration of the angled chambers 207A and 207C (and, in addition or optionally, via angled surfaces as discussed supra) and non-angled chamber 207B.

In FIG. 7, multiple LEDs 202A, 202B, and 202C are positioned within respective chambers 207A, 207B, and 207C. Multiple images can be projected on a single area 216B (as described with respect to area 216A in FIG. 6). Additionally in FIG. 7, images can also be projected at multiple locations 216A, 216B, and 216C. Thus, multiple images are driven by multiple LEDs at one or more locations. A single LED light source 202A is positioned within a single chamber 207A and light paths 214A and 214A′ are formed by light emitted from LED light source 202A along longitudinal axis 213A through transmissive display 206, and at an angle relative to the respective longitudinal axis 213A through transmissive display 206, respectively. Similarly, a single LED light source 202C is positioned within a single chamber 207C and light paths 214C and 214C′ are formed by light emitted from LED light source 202C along longitudinal axis 213C through transmissive display 206 and at an angle relative to the longitudinal axis 213C, respectively. Thus, LED 202A can project a first image onto area 216A and a second image onto area 216B. In an example embodiment, by switching quickly enough from a first image projected onto area 216A to a second image projected onto area 216B, it can appear to a user that the image moved from area 216A to area 216B along the surface.

According to a further embodiment, additional LED light sources within respective additional angled chambers are contemplated, for the purpose of providing the option of additional projected images to the one or more areas or to separate the areas to provide additional indications (e.g., low battery).

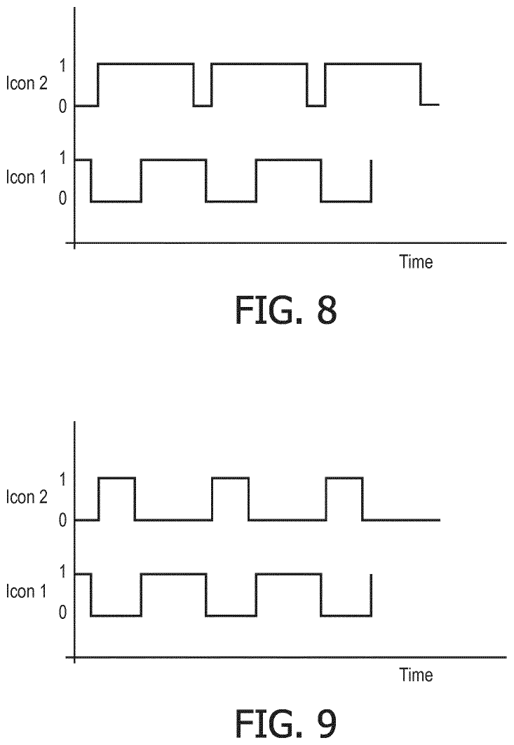

In FIG. 8, a graphical illustration of time sharing multiple icons at one or more locations is illustrated. Time sharing multiple icons produces the appearance of a dynamic image. The projections of “Icon 1” and “Icon 2” are shown over time. The “0” indicates an off state and the “1” indicates an on state. In FIG. 8, Icon 1 is projected while Icon 2 is not projected at the start. As time passes, Icon 1 is turned off and then Icon 2 is projected. Thereafter, Icon 2 is turned off and then Icon 1 is projected again. This pattern repeats. In this type of time sharing, Icon 2 is never projected when Icon 1 is projected. The periods of time when Icon 1 is projected are longer than the periods of time when Icon 2 is projected.

FIG. 9 shows another graphical illustration of time sharing multiple images at one or more locations. In FIG. 9, (similar to the representation shown in FIG. 8) Icon 1 is projected while Icon 2 is not projected at the start. As time passes (also similar to the representation shown in FIG. 8), Icon 1 is turned off and then Icon 2 is projected. Thereafter, in contrast to what is depicted in FIG. 8, Icon 1 is projected while Icon 2 is still being projected and Icon 2 is turned off while Icon 1 is still being projected. Then, Icon 1 is turned off while Icon 2 is turned off. Next, Icon 2 turns on while Icon 1 is turned off. While Icon 2 is projected, Icon 1 is then turned on. This pattern repeats. In this type of time sharing, there are periods of time when both Icon 1 and Icon 2 are projected at the same time. The periods of time when Icon 2 is projected are longer than the periods of time when Icon 1 is projected.

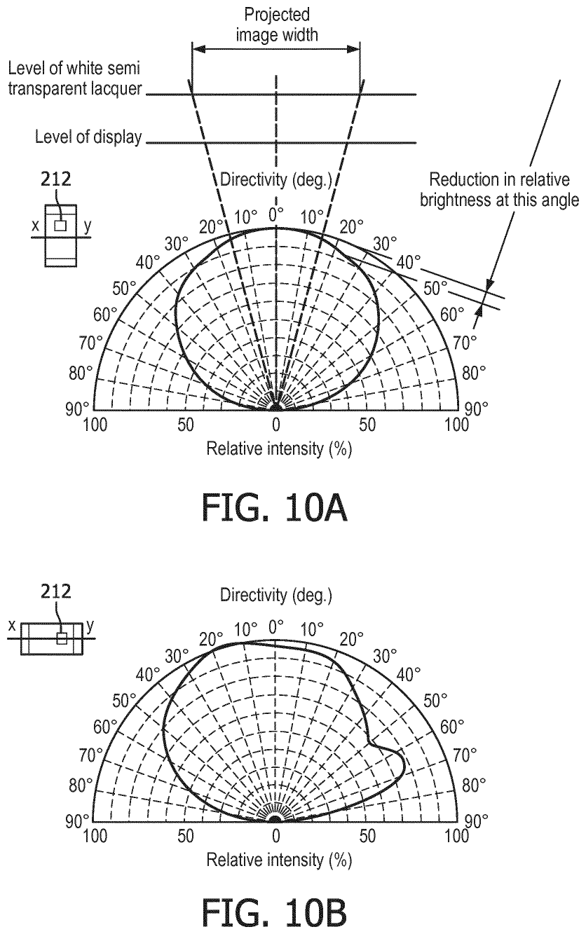

According to another embodiment, it can be advantageous for the LED light sources to be used with a limited angle dependent intensity profile in two directions so that maximum light intensity/brightness evenness between mixed LED light source projections can be achieved. Referring to FIGS. 10A and 10B, graphical illustrations of an angle dependent intensity profile of an LED light source in two directions with respect to an image 212 and the effect on projected image intensity are shown. Directivity of the emitted light which is used to project the image is shown vs. relative intensity, with the level of the transmissive display, the level of the white semitransparent lacquer, and the projected image profile/width being shown. A particular 30 degree range of light emission angle is shown as ideal for an advantageous maximum light intensity/brightness evenness, which would provide the widest and most advantageous projected image profile. Anything greater than this 30 degree range shows a reduction in relative brightness, although could still be used.

For example, as shown in FIG. 10A, in order to obtain the widest profile for the projected image possible while maintaining maximum light intensity/brightness evenness between mixed LED light source projections, an LED light source can be angled 15 degrees one way or the other in one plane from a zero position (where the zero position is directly aimed at a common area as is LED light source 202B along longitudinal axis 213B, and LED light sources 202A and 202C can be aimed at the common area and angled 15 degrees or less from the respective longitudinal axes 214A and 214C, for example, as shown in FIGS. 6 and 7), which maintains an ideal relative intensity profile of each LED light source between 90 and 100%. The angle of the respective chambers 207A and 207C, the distances of the LED's from the common area (to the left or the right when looking at FIGS. 6 and 7), and the surfaces—whether angled or not—where the LED light sources 202A and 202C are positioned—each affect the relative intensity profile of LED light sources 202A and 202C.

The structural configuration and functionality of the power toothbrush projected display system 200 discussed above allows for multiple display configurations and provides for a variety of brushing information/indications to a user of a power toothbrush (as described above).

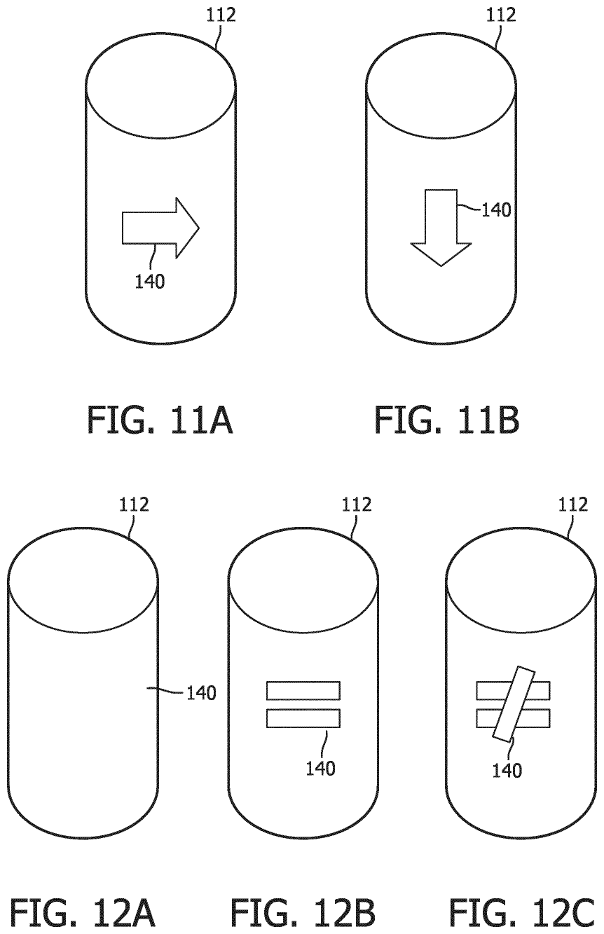

Turning to FIGS. 11A and 11B, multiple images are shown displayed on the same common area of a tubular body of a power device. For example, body portion/handle 112 includes a display area 140 that includes Image 1 (a side facing arrow) being projected. In FIG. 11B, a different image, Image 2 (a down facing arrow) is shown as being projected at the display area 140. To transition between Image 1 and Image 2 and vice versa, the segments of the transmissive display 206 are turned “on” and “off” individually in steps to either block or allow light to pass through under changing angles. In an example embodiment, Images 1 and 2 can be transitioned at a comparable intensity level. The order of the transitioning of images can vary, and the colors of each of the images can transition into the colors of another image.

In an example embodiment, as opposed to transitioning between differing images, an image can change in size over time. For example, an arrow can be initially projected at a first size and increase or decrease in size over a period of time.

Referring to FIGS. 12A-12C, merging/blending images are shown displayed on the same common area of a tubular body of a power device. For example, body portion/handle 112 includes a display area 140 that is in the “off” position in FIG. 12A (no image is projected). In FIG. 12B, Image 1 (equal sign) is shown as being on and projected at the display area 140. In FIG. 12C, an additional Image 2 (a slash) is shown as being on and projected over Image 1 at the display area 140. The color of one of the images can merge/blend with the color of the other image.

Even though a number of exemplary embodiments of images are shown and described herein, many other images are contemplated that could provide the user of the power device with information/indications about the device or use thereof. Moreover, similarly to the images discussed above, a single color, fading or transitioning colors, and/or merging or blending colors could provide the contemplated information/indications.

A method for displaying multiple images on one or more areas of a power device is disclosed. A housing may be provided and configured to contain (i) a first light source, (ii) a mask arranged around the first light source, and including a first chamber, and (iii) a transmissive display arranged between the first light source and a surface of the power device. Emitted light from the first light source can reach the transmissive display before reaching the surface of the power device and project multiple images on the one or more areas. The emitted light is selectively obstructed by one or more transparent areas defined in the transmissive display.

In an example method for displaying multiple images on one or more areas of the power device, at least two images are projected on the one or more areas depending on an activation of sub-units of the transmissive display and the first light source as follows: (i) a first image is projected; (ii) the first image is turned off; (iii) a second image is projected; and (iv) the first image is projected before the second image is turned off to create a dynamic blending of the first and second images.

In an example method for displaying multiple images on one or more areas of the power device, at least two images are projected on the one or more areas depending on an activation of sub-units of the transmissive display and the first light source as follows: (i) a first image is projected; (ii) the first image is turned off; (iii) a second image is projected; and (iv) the second image is turned off before the first image is projected again to create a dynamic blending of the first and second images.

A method for selectively displaying images on one or more surfaces of a housing in accordance with an embodiment is disclosed. A housing may be provided and configured to contain the following: (i) one or more light sources, (ii) a mask arranged around each of the one or more light sources and including one or more chambers corresponding to the one or more light sources, and (iii) a transmissive display arranged between the one or more light sources and the one or more surfaces. Light from a first of the one or more light sources is emitted. The emitted light from the first of the one or more light sources can reach the transmissive display before reaching the surface, and can project a corresponding first image on one or more areas on the surface.

In an example method for selectively displaying images on one or more surfaces of a housing, light from a second of the one or more light sources is emitted. The emitted light from the second of the one or more light sources can reach the transmissive display before reaching the surface, and can project a corresponding second image on one or more areas on the surface. The combination of the first and second images can create a blended image on the one or more areas on the surface. Alternatively, the first image can transition to the second image, or the combination of the first and second images can create the appearance of a moving image.

The projected images discussed herein can be projected on a planar surface of a power device or a curved surface of a power device. When images are projected on a curved surface, the images are projected to partially wrap around the curved outer surface of the housing 205—providing a large angle display. This “wrapping” feature can be accomplished by a mask arrangement that directs light emitted from the multiple light sources in a diverging manner to separate areas on the curved outer surface of the housing. Alternatively, the outer surfaces of the housing could include at least one flat surface. In other words, the masks that surround and form the chambers that house each of the light sources can be angled in a particular manner/configuration within the housing 205 to provide the “wrapping” feature (by, in part, projecting an image corresponding to the transmissive display in separate areas on the curved outer surface of the housing 205).

The mask 204 of the projected display system 200 can be formed by injection molding. The mask 204 can be injection molded in an open position including two portions hinged together. It can be advantageous to injection mold the mask 204 in the open position, as it is easier to remove the mask from the mold. After removal, the mask 204 can be assembled by folding the open portions of the mask together.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A power device, comprising:
a first light source arranged in a housing having an outer surface;
a first mask arranged around the first light source in the housing and including a first chamber corresponding to the first light source; and
a transmissive display arranged between the first light source and the outer surface of the housing, light emitted from the first light source reaching the transmissive display before reaching the outer surface of the housing and projecting a plurality of images on a first area on the outer surface of the housing.

2. The power device of claim 1, wherein the first light source is a single color light emitting diode.

3. The power device of claim 1, wherein the first light source is a multi-color light emitting diode.

4. The power device of claim 1, wherein the transmissive display is a transmissive matrix display or a transmissive segment display.

5. The power device of claim 1, wherein the projected images are created on a semitransparent paint system.

6. The power device of claim 1, further comprising a second light source arranged proximate to the first light source and within the first chamber.

7. The power device of claim 6, wherein the first and second light sources comprise a respective longitudinal axis, and light emitted from the first light source on the first area of the housing at least partially overlaps with light emitted from the second light source on the first area of the housing.

8. The power device of claim 1, further including a second light source arranged in a second chamber in the housing, light emitted from the second light source reaching the transmissive display before reaching the outer surface of the housing and projecting a second plurality of images on a second area on the outer surface of the housing, wherein the first and second chambers are not angled.

9. A power device, comprising:
a plurality of light sources arranged in a housing having an outer surface;
a plurality of chambers corresponding to the plurality of light sources;
a mask arranged around each of the plurality of light sources and chambers in the housing; and
a transmissive display arranged between the plurality of light sources and the outer surface of the housing, wherein light emitted from each of the plurality of light sources reaches the transmissive display before reaching the outer surface of the housing and projecting a plurality of images on at least two separate areas on the outer surface of the housing.

10. The power device of claim 9, wherein at least one of the plurality of chambers includes an angled surface and a non-angled surface.

11. The power device of claim 9, wherein the plurality of images being projected on the outer surface of the housing wraps around the outer surface.

12. A method of displaying multiple images on one or more areas of a power device, including the steps of:
providing a housing containing a first light source, a mask arranged around the first light source, and including a first chamber, and a transmissive display arranged between the first light source and the one or more areas of the power device;
causing light to be emitted from the first light source, the emitted light reaching the transmissive display before reaching the one or more areas; and
selectively obstructing the emitted light by defining one or more transparent areas in the transmissive display to project multiple images on the one or more areas of the power device.

13. The method of claim 12, further comprising:
causing a projection of two images on the one or more areas of the housing depending on activation of sub-units of the transmissive display in a following sequence and the first light source:
projecting a first image;
turning off the first image;
projecting a second image; and
projecting the first image before turning off the second image to create a dynamic blending of the first and second images.

14. The method of claim 12, further comprising:
causing a projection of two images on the one or more areas of the housing depending on activation of sub-units of the transmissive display in a following sequence and the first light source:
projecting a first image;
turning off the first image;
projecting a second image; and
turning off the second image before projecting the first image again to create a dynamic blending of the first and second images.

15. The method of claim 12, wherein the step of selectively obstructing the emitted light comprises projecting a first image and a second image alternatingly such that they appear to be projected at a same time.
